(19) United States
(12) Patent Application Publication
(10) Pub. No.: US 2015/0341513 A1
(43) Pub. Date: Nov. 26, 2015

(54) SCANNER

(71) Applicant: AVISION INC., Hsinchu (TW)

(72) Inventors: Yen-Cheng Chen, Hsinchu (TW); Sei-For Hsu, Hsinchu County (TW)

(21) Appl. No.: 14/560,753

(22) Filed: Dec. 4, 2014

(30) Foreign Application Priority Data
May 20, 2014 (TW) 103208798

(51) Int. Cl. H04N 1/00; H04N 1/12

(52) U.S. Cl. CPC H04N 1/00559; H04N 1/00018; H04N 1/121; H04N 1/00525; H04N 2201/0081

(57) ABSTRACT

A scanner comprising a scan channel and a background strip is disclosed. The background strip is disposed on a side of the scan channel and has a correction area and two scan background areas. The correction area is located between the two scan background areas.

This application claims the benefit of Taiwan application Serial No. 103208798, filed May 20, 2014, the subject matter of which is incorporated herein by reference.

### BACKGROUND OF THE INVENTION

1. Field of the Invention

The invention relates in general to a scanner, and more particularly to a scanner having improvements with background strip.

2. Description of the Related Art

Generally known scanners have many different types including flatbed scanner, sheetfed scanner and multi-function printer (MFP). In practical use, the flatbed scanner is subjected to many restrictions. For example, the cover can only be lifted manually, only a limited amount of documents can be scanned each time, the volume is too big, and the scan speed is too slow. The sheetfed scanner can be a business card scanner capable of scanning business cards only or can be a scanner capable of scanning business cards, photos and ordinary documents as well. The sheetfed scanner has small volume, light weight, and fast speed, and is capable of automatically scanning a large amount of documents in a batch. The MFP provides many functions including scan, print, copy, facsimile, and image processing, but is expensive and is inconvenient to carry with. Therefore, for those who have a need for automatic scan of documents, the sheetfed scanner is a preferred choice.

FIG. 1 is a schematic diagram of a background strip according to prior art. As indicated in FIG. 1, the background strip 13 of the sheetfed scanner is strip-shaped, two correction areas 12 are located at two terminals of the background strip 13 for correcting image, and the scan background area 11 is located between the two correction areas 12. The scan module scans images of the correction areas 12, compares the scanned image with the standard correction data stored in the scan module (the standard correction data is in-built before the scan module leaves the factory), and accordingly adjusts the colors or brightness of the output image. However, the length of the background strip 13 is restricted due to the positions of the two correction areas 12 and cannot be reduced. The disposition of the correction area 12 makes the scan area relatively crowded. Therefore, the volume of the scanner cannot be miniaturized and the cost cannot be reduced.

Besides, the optical sensor in charge of receiving scan data has a limited sensing range, and may be incapable of sensing the correction areas at two terminals of the background strip if the length of the background strip is outside the sensing range. Such circumstance is not conducive to correction. In other words, when the sensing range of the optical sensor is fixed and the length of the corresponding background strip is also fixed, the size of the scan background area will be restricted, and the scan size of the document will be shrunk if the optical sensor must be capable of receiving the correction data of the correction area.

Also, the disposition of the correction areas at two terminals of the background strip is not conducive to image cropping. In general, the correction area prefers to use white color, which is close to the color of the san document (most of the san document is white). However, if the color of the correction area is too close to that of the scan document and makes the border of the document image hard to identify, delicate image processing such as image cropping and skew correction cannot be performed.

### SUMMARY OF THE INVENTION

The invention is directed to a scanner having improvements with background strip for resolving the unresolved problems of the prior art.

According to an aspect of the present invention, a scanner is disclosed. The scanner comprises a scan channel and a background strip. The background strip is disposed on a side of the scan channel and has a correction area and two scan background areas. The correction area is located between the two scan background areas.

In an embodiment of the present invention, the scanner comprises a scan module disposed on another side of the scan channel and separated from the background strip by a gap. After a document is loaded into the scan channel, the scan module captures an image of the correction area before the document passes through the scan module and the background strip, and captures an image of the document and an image of the two scan background areas to generate a scan data after the document passes through the space between the scan module and the background strip.

In an embodiment of the present invention, the scanner further comprises a processor electrically connected to the scan module for receiving the scan data composed of the image of the correction area, the image of the two scan background areas and the image of the document. The processor identifies the image of the document according to the scan data.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a background strip according to prior art.

FIG. 2 is a longitudinal view of a scanner according to an embodiment of the invention.

FIG. 3 is a latitudinal view of a scanner according to an embodiment of the invention.

FIG. 4 is an image file of scan data.

FIG. 5 is a block diagram of a scanner according to an embodiment of the invention.

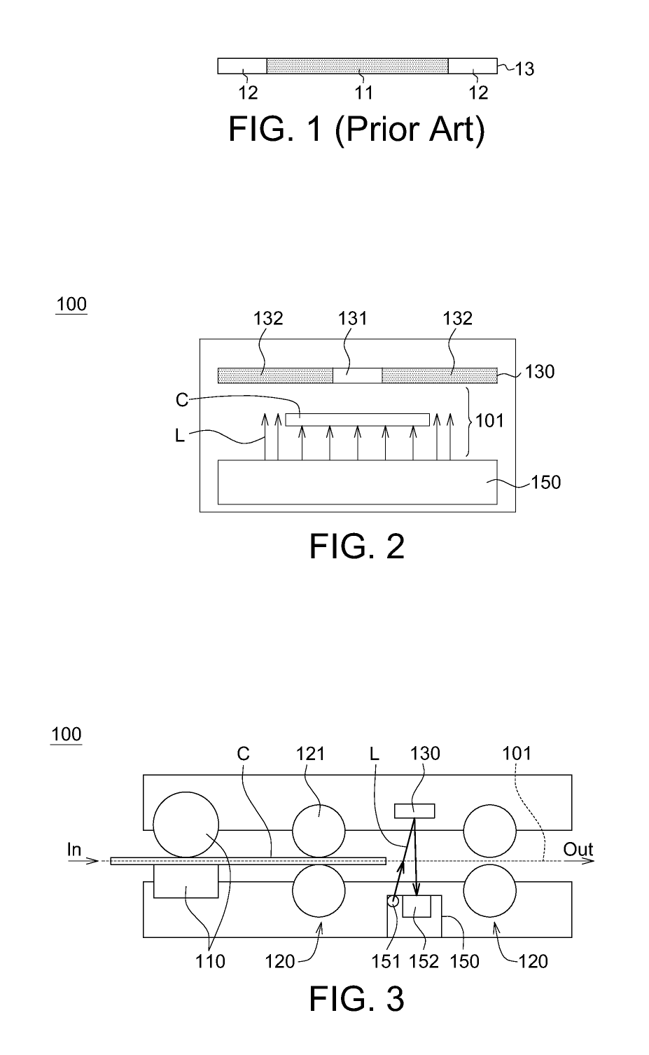

### DETAILED DESCRIPTION OF THE INVENTION

In an exemplary example of the present embodiment, a scanner having improvements with background strip is disclosed. A correction area of the background strip is located between two scan background areas. Since the correction area is located at a central region of the background strip and the two scan background areas are located at two terminal regions of the background strip, the length of the background strip, which could not be reduced due to the positions of conventional correction areas (located at two terminals of the background strip) and can now be reduced further. Therefore, the volume of the scanner can be miniaturized to reduce the cost.

On the other hand, the design of disposing the two scan background areas at two terminal regions of the background strip relatively increases the scan size of the document. Since the correction area is located at the central region of the background strip, the sensing range of the optical sensor in charge of receiving the scan data must cover the correction area, and the optical sensor must be capable of receiving the correction data of the correction area. Within a fixed sensing range of the optical sensor, the length of the background strip is also fixed. As the size of the scan background area relatively increases, conventional restrictions in the size of scan document (that is, the size of conventional scan background area is restricted) can thus be resolved.

A number of embodiments are disclosed below with accompanying drawings for elaborating the invention. However, the embodiments of the invention are for detailed descriptions only, not for limiting the scope of protection of the invention.

Refer to FIG. 2 and FIG. 3. FIG. 2 is a longitudinal view of a scanner 100 according to an embodiment of the invention. FIG. 3 is a latitudinal view of a scanner 100 according to an embodiment of the invention. As indicated in FIG. 2, the scanner 100 comprises a scan channel 101, a background strip 130 and a scan module 150, but the feedback unit 110 and the transfer module 120 are not illustrated. The document C is loaded into the scan channel 101 in a direction perpendicular to the drawing. The feedback unit 110 and the transfer module 120 are illustrated in FIG. 3. As indicated in FIG. 3, the feedback unit 110 is disposed at an inlet In of the scan channel 101 for loading the document C into the scanner 100. The transfer module 120 is disposed in the scan channel 101 for transferring the document C to pass through the scan channel 101. The transfer module 120 comprises several roller assemblies 121 respectively disposed at the inlet In and the outlet Out of the scan channel 101 or at the front or the rear of the scan module 150. The roller assemblies 121 clamp the upper and lower surfaces of the document C and provide a suitable driving force for transferring the document C forward along the scan channel 101.

As indicated in FIG. 2, the background strip 130 is disposed on a side of the scan channel 101 and the scan module 150 is disposed on the other side of the scan channel 101, such that the background strip 130 and the scan module 150 are opposite to each other and separated from each other by a gap. Besides, the background strip 130 has a correction area 131 (represented by white background) and the two scan background areas 132 (represented by black background), and the correction area 131 is located between the two scan background areas 132. The correction area 131 can be a brightness correction strip or a chromaticity correction strip, and the scanner stores a standard correction data corresponding to the correction area 131 for the use of correcting the scan data.

In an embodiment, the scan background area 132 has a dark color (such as black), and the correction area 131 has a light color (such as white); or, the scan background area 132 has a light color (such as white), and the correction area 131 has a dark color (such as black). In general, the color of the scan background area 132 is preferably different from that of the scan document C. In an embodiment, the correction area 131 can be formed by a patch or a coating layer formed on the background strip 130. The color of the patch or the coating layer is different from that of the background strip 130, such that the area covered by the patch or the coating layer can be identified as a correction area 131 and the area not covered by the patch or the coating layer forms two scan background areas 132. According to another method: the two scan background areas 132 can be formed by two patches or two coating layers formed on the background strip 130. The color of the two patches or the two coating layers is different from that of the background strip 130, and the area not covered by the two patches or the two coating layers can be identified as a correction area 131.

Refer to FIG. 2. Since the correction strip is located at the central region of the background strip 130 instead of the two sides of the background strip 130, the maximum scan size of the document is equivalent to the size of the background strip 130. If the correction strip is located at one or two sides of the background strip according to the conventional method, the maximum scan size of the document will be smaller than the size of the background strip.

Refer to FIGS. 2 and 3. After the document C is loaded into the scan channel 101, the scan light source 151 is activated to emit a light beam L for scanning the document C. Before the document C passes through the space between the scan module 150 and the background strip 130, the scan module 150 captures an image of the correction area 131. After the document C passes through the space between the scan module 150 and the background strip 130, the scan module 150 captures an image of the document C and an image of two scan background areas 132 to generate a scan data.

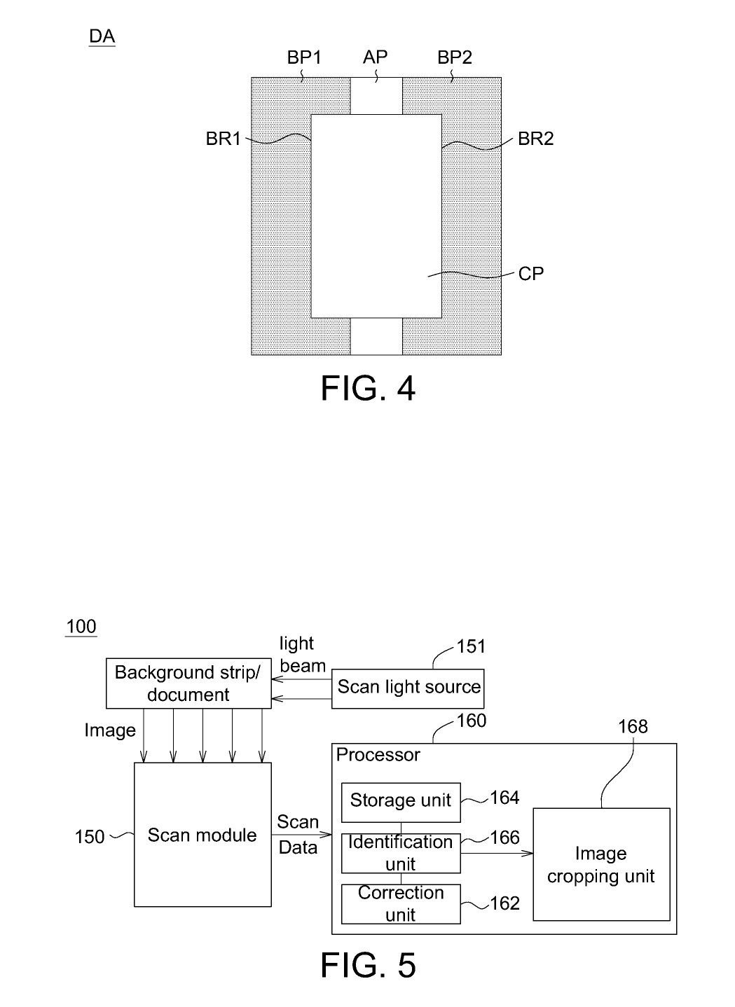

Referring to FIG. 4, an image file of scan data DA is shown. In an embodiment, the scan data DA is composed of images captured by the scan module 150 comprising an image AP (represented by white background) of the correction area 131, images BP1 and BP2 (represented by black background) of the two scan background areas 132 and a document image CP (represented by white background) to form an image file with a predetermined size. In general, the color of the scan background area 132 is different from that of the document so that the document image can be identified. As indicated in FIG. 4, a left border BR1 is formed between the image BP1 at the left-hand side of the scan background area and the document image CP, and a right border BR2 is formed between the image BP2 at the right-hand side of the scan background area and the document image CP. Thus, the border, shape and size of the document image CP can be obtained by the processor (or software) through the analysis of the distribution and background data of the image.

Refer to FIGS. 4 and 5. FIG. 5 is a block diagram of a scanner 100 according to an embodiment of the invention. As indicated in FIG. 5, after the document C and the background strip 130 reflect the light beam emitted from the scan light source 151, the scan module 150 (comprising an optical sensor) captures an image of the document C and an image of the background strip 130 to generate a scan data DA. In addition, the scanner 100 may comprise a processor 160 located inside the scanner 100 or inside the control unit of a computer. The processor 160 is connected to the scan module 150 for receiving the scan data DA and identifying the document image CP.

In an embodiment, the processor 160 comprises a correction unit 162, a storage unit 164 and an identification unit 166. The correction unit 162 can be a chromaticity correction unit or a brightness correction unit, for example. The storage unit 164 stores a background data corresponding to each scan background area 132 and a standard correction data corresponding to the correction area 131. The identification unit 166 identifies the document image CP from the scan data DA according to the background data stored in the storage unit 164.

The correction unit 162 is connected to the storage unit 164, and compares the image CP of the correction area 131 captured by the scan module 150 with the standard correction data stored in the storage unit 164 to correct the scan data DA. For example, the correction unit 162 corrects either or both of the chromatic value and brightness of the scan data DA.

The correction unit 162, the storage unit 164 and the identification unit 166 can be formed by components of an integrated circuit, such as memories and chip sets. Also, the correction unit 162, the storage unit 164 and the identification unit 166 can be formed by independent components.

In short, the identification unit 166, according to the background data and the scan data, obtains the area and position of the scan data shielded by the document image CP for identifying the border, shape and size of the document image CP. The identification unit 166 further judge whether the document image CP is skewed and needs to be corrected.

In an embodiment, the processor 160 further comprises an image cropping unit 168 connected to the identification unit 166 for cropping the document image CP of the scan data.

According to the scanner disclosed in the above embodiments of the invention, the length of the background strip, which could not be reduced due to the positions of conventional correction areas (located at two terminals of the background strip) and can now be reduced further. Therefore, the volume of the scanner can be miniaturized to reduce the cost. Moreover, the document image and the background image can be differentiated from the scan data, so that subsequent image processing can be conducted precisely and the unresolved problems of the prior art can thus be resolved accordingly.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scanner, comprising:
a scan channel; and
a background strip disposed on a side of the scan channel, wherein the background strip has a correction area and two scan background areas, and the correction area is located between the two scan background areas.

2. The scanner according to claim 1, wherein the scanner comprises a scan module disposed on the other side of the scan channel and separated from the background strip by a gap, and after a document is loaded into the scan channel, the scan module captures an image of the correction area before the document passes through the space between the scan module and the background strip, and further captures an image of the document and an image of the two scan background areas to generate a scan data after the document passes through the space between the scan module and the background strip.

3. The scanner according to claim 2, further comprising a processor electrically connected to the scan module for receiving the scan data composed of the image of the correction area, the image of the two scan background areas and the image of the document, wherein the processor identifies the image of the document according to the scan data.

4. The scanner according to claim 3, wherein the processor further comprises a storage unit storing a background data corresponding to each scan background area and a standard correction data corresponding to the correction area.

5. The scanner according to claim 4, wherein the processor identifies the image of the document from the scan data according to the background data.

6. The scanner according to claim 4, wherein the processor further comprises a correction unit connected to the storage unit, the correction unit compares the image of the correction area captured by the scan module with the standard correction data to correct the scan data.

7. The scanner according to claim 3, wherein the processor further comprises an image cropping unit cropping the image of the document from the scan data.

8. The scanner according to claim 1, wherein the correction area is a chromaticity correction area, a brightness correction area or a combination thereof.

9. The scanner according to claim 1, wherein the correction area is a patch or a coating layer formed on the background strip, and color of the patch or the coating layer is different from color of the background strip.

10. The scanner according to claim 1, wherein the two scan background areas are two patches or two coating layers formed on the background strip, and colors of the two patches or the two coating layers is different from color of the background strip.
